(19) United States
(12) Patent Application Publication
(10) Pub. No.: US 2018/0111457 A1
(43) Pub. Date: Apr. 26, 2018

(54) VEHICLE BACK DOOR STRUCTURE

(71) Applicant: TOYOTA JIDOSHA KABUSHIKI KAISHA, Toyota-shi (JP)

(72) Inventor: Hiroyuki MORI, Ichinomiya-shi (JP)

(73) Assignee: TOYOTA JIDOSHA KABUSHIKI KAISHA, Toyota-shi (JP)

(21) Appl. No.: 15/718,500

(22) Filed: Sep. 28, 2017

(30) Foreign Application Priority Data
Oct. 24, 2016 (JP) 2016-207616

(51) Int. Cl. B60J 5/10; B62D 35/00; B60J 10/70

(52) U.S. Cl. CPC B60J 5/107; B60J 1/18; B60J 10/70; B62D 35/007

(57) ABSTRACT

The present invention provides a vehicle back door structure that has: a rear window that is inclined toward a vehicle lower side while heading toward a vehicle rear side; a back door main body that is joined to a reverse surface side of a rear end portion of the rear window, and that is provided so as to extend from the rear end portion of the rear window toward the vehicle rear side; a rear spoiler that is provided at an upper side in a vertical direction of the back door main body; a sealing member that is provided at a mating portion of the rear end portion of the rear window and a front end portion of the rear spoiler, and that seals between the rear end portion of the rear window and the back door main body; and a lip portion that is formed at the sealing member, and extends from the reverse surface side of the rear end portion of the rear window and contacts a reverse surface side of the front end portion of the rear spoiler, and that has, at least one place thereof in a vehicle transverse direction, slits that communicate the mating portion side and an obverse side of the back door main body.

### CROSS-REFERENCE TO RELATED APPLICATION

This application is based upon and claims the benefit of priority of the prior Japanese Patent Application No. 2016-207616, filed on Oct. 24, 2016, the entire contents of which are incorporated herein by reference.

### FIELD

The embodiments discussed herein are related to a vehicle back door structure.

### BACKGROUND

Patent Document 1 (Japanese Patent Application Laid-Open (JP-A) No. 2016-037262) describes a back door structure that includes an upper side window and a lower side window, a rear spoiler disposed between the upper side window and the lower side window, and a back door frame that supports the upper side window, the lower side window and the rear spoiler. This back door structure is provided with a resin panel in which a window portion that serves as the upper side window and a spoiler portion that serves as the rear spoiler are made integral by resin molding. Note that there is the structure described in Cited Document 2 (JP-A No. H5-004520) as a vehicle lift gate structure in which a garnish, which connects the rear end portion of an inclined back window and the upper end portion of a substantially vertical window, is made integral with the upper end portion of the substantially vertical window.

At a vehicle back door, there are cases in which a lip for preventing the gap from being visible is provided at the mating portion of the upper side window and the rear spoiler. In the back door structure of Patent Document 1 (JP-A No. 2016-037262), a concave portion that is recessed toward the vehicle lower side is provided at the mating portion of the upper side window and the rear spoiler. Also in cases in which a lip is provided at the concave portion, there is the possibility that water will collect in the concave portion, and there is room for improvement.

### SUMMARY

In view of the above-described circumstances, an object of the present invention is to provide a vehicle back door structure in which collecting of water at a mating portion of a rear window and a rear spoiler can be suppressed.

A vehicle back door structure relating to a first aspect has: a rear window that is inclined toward a vehicle lower side while heading toward a vehicle rear side; a back door main body that is joined to a reverse surface side of a rear end portion of the rear window, and that is provided so as to extend from the rear end portion of the rear window toward the vehicle rear side; a rear spoiler that is provided at an upper side, in a vertical direction, of the back door main body; a sealing member that is provided at a mating portion of the rear end portion of the rear window and a front end portion of the rear spoiler, and that seals between the rear end portion of the rear window and the back door main body; and a lip portion that is formed at the sealing member, extends from the reverse surface side of the rear end portion of the rear window and contacts a reverse surface side of the front end portion of the rear spoiler, and that has, at least one place thereof in a vehicle transverse direction, slits that communicate a mating portion side and an obverse side of the back door main body.

In accordance with the vehicle back door structure of the first aspect, the back door main body is joined to the reverse surface side of the rear end portion of the rear window. The back door main body is provided so as to extend from the rear end portion of the rear window toward the vehicle rear side. The rear spoiler is provided at the upper side in the vertical direction of the back door main body. The sealing member is provided at the mating portion of the rear end portion of the rear window and the front end portion of the rear spoiler. The lip portion, which extends from the reverse surface side of the rear end portion of the rear window and contacts the reverse surface side of the front end portion of the rear spoiler, is formed at the sealing member. The lip portion has, at least one place thereof in the vehicle transverse direction, slits that communicate the mating portion side and the obverse side of the back door main body. Due thereto, in a case in which water that flows on the rear window flows to the mating portion of the rear end portion of the rear window and the front end portion of the rear spoiler, the water passes-through the slits of the lip portion and flows to the obverse of the back door main body that is at the lower side of the rear spoiler. Due thereto, water collecting at the mating portion of the rear end portion of the rear window and the front end portion of the rear spoiler is suppressed.

In a vehicle back door structure relating to a second aspect, in the vehicle back door structure of the first aspect, the rear window and the rear spoiler have, at vehicle transverse direction central portions thereof, concave surfaces that are recessed toward the vehicle lower side, and the slits of the lip portion are provided at least at a position corresponding to the concave surfaces.

In accordance with the vehicle back door structure of the second aspect, the rear window and the rear spoiler have, at vehicle transverse direction central portions thereof, concave surfaces that are recessed toward the vehicle lower side. The slits of the lip portion are provided at least at a position that corresponds to the concave surfaces. Due thereto, water, which has flowed to the low position that is the concave surfaces, passes-through slits of the lip portion, and can flow to the obverse of the back door main body that is at the lower side of the rear spoiler, and water does not collect in the concave surfaces. Therefore, water that has collected in the concave surfaces flowing from the front end portion of the rear window into the vehicle cabin interior at the time when the back door is opened is suppressed, and the degrees of freedom in design can be improved.

In a vehicle back door structure relating to a third aspect, in the vehicle back door structure of the first aspect, the slits of the lip portion are formed in shapes of steps as seen from the vehicle rear side along a surface of the rear window.

In accordance with the vehicle back door structure of the third aspect, as seen from the vehicle rear side along the surface of the rear window, the slits of the lip portion are formed in the shapes of steps. Due thereto, the back door main body that is at the lower side being seen from the slits is suppressed, and a deterioration in appearance is suppressed. Further, in a case in which the back door main body is formed of a resin such as a carbon-fiber-reinforced plastic (CFRP) or the like for example, deterioration of the back door main body due to ultraviolet light can be suppressed.

In a vehicle back door structure relating to a fourth aspect, in the vehicle back door structure of the first aspect, the slits of the lip portion are formed in shapes of inclined surfaces as seen from the vehicle rear side along a surface of the rear window.

In accordance with the vehicle back door structure of the fourth aspect, as seen from the vehicle rear side along the surface of the rear window, the slits of the lip portion are formed in the shapes of inclined surfaces. Due thereto, the back door main body that is at the lower side being seen from the slits is suppressed, and a deterioration in appearance is suppressed. Further, in a case in which the back door main body is formed of a resin such as a carbon-fiber-reinforced plastic (CFRP) or the like for example, deterioration of back door main body due to ultraviolet light can be suppressed.

In a vehicle back door structure relating to a fifth aspect, in the vehicle back door structure of the first aspect, the back door main body has, at least a portion thereof in the vehicle transverse direction, an inclined portion that is sloped downward while heading toward the vehicle rear side and at which water, which has passed through the slits, flows toward the vehicle rear side, and a drainage portion, from which water that has flowed at the inclined portion is discharged, is provided between a rear end portion side of the back door main body and a rear portion side of the rear spoiler.

In accordance with the vehicle back door structure of the fifth aspect, the back door main body has, at least a portion thereof in the vehicle transverse direction, the inclined portion that is sloped downward while heading toward the vehicle rear side. Water that has passed through the slits flows on the obverse of the inclined portion toward the vehicle rear side. Moreover, the water that has flowed on the inclined portion is discharged-out from the drainage portion that is provided between the rear end portion side of the back door main body and the rear portion side of the rear spoiler. Therefore, stagnating of the water, which has passed through the slits and flowed on the obverse of the back door main body, is suppressed, and the water can be discharged-out smoothly from the drainage portion.

In a vehicle back door structure relating to a sixth aspect, in the vehicle back door structure of the first aspect, the sealing member is mounted to a reverse surface of the rear end portion of the rear window, and the lip portion contacts a reverse surface side of the front end portion of the rear spoiler.

In accordance with the vehicle back door structure of the sixth aspect, the sealing member is mounted to the reverse surface of the rear end portion of the rear window, and the lip portion contacts the reverse surface side of the front end portion of the rear spoiler. Therefore, it is easy to form, at the lip portion, slits that communicate the mating portion side and the obverse side of the back door main body.

In a vehicle back door structure relating to a seventh aspect, in the vehicle back door structure of the first aspect, the sealing member has a base portion that is disposed at a vehicle front side and whose length in a vehicle vertical direction is long, and a length of the lip portion in the vehicle vertical direction is shorter than that of the base portion, and the lip portion is disposed at a vehicle rear side of the base portion.

In accordance with the vehicle back door structure of the seventh aspect, the sealing member has the base portion that is disposed at the vehicle front side and whose length in the vehicle vertical direction is long. The lip portion, whose length in the vehicle vertical direction is shorter than that of the base portion, is disposed at the vehicle rear side of the base portion. Therefore, it is easy to form, at the lip portion, slits that communicate the mating portion side and the obverse side of the back door main body.

In accordance with the vehicle back door structure relating to the present disclosure, water collecting at a mating portion of a rear window and a rear spoiler can be suppressed.

### BRIEF DESCRIPTION OF DRAWINGS

FIG. 1 is a perspective view in which a vehicle, to which a vehicle back door structure relating to a first embodiment is applied, is viewed from an obliquely rear side.

FIG. 2 is a side view showing a state in which a back door relating to the first embodiment is disposed at an open position.

FIG. 3 is a cross-sectional view showing an inner panel, and a mating portion of a rear window and a rear spoiler, which are provided at the back door relating to the first embodiment.

FIG. 4 is a cross-sectional view (a cross-sectional view of a lip portion along line 4-4 of FIG. 3) that shows the lip portion of a sealing member that is provided at the back door relating to the first embodiment.

FIG. 5 is a perspective view in which the sealing member, which is provided at the back door relating to the first embodiment, is seen from an obliquely rear side.

FIG. 6A is a cross-sectional view showing a sealing member that is used in a vehicle back door structure relating to a second embodiment.

FIG. 6B is a plan view showing a portion of the sealing member that is used in the vehicle back door structure relating to the second embodiment.

FIG. 6C is a rear view showing a portion of the sealing member that is used in the vehicle back door structure relating to the second embodiment.

FIG. 7 is a cross-sectional viewing showing a mating portion of the rear window and the rear spoiler that are provided at a vehicle back door structure relating to a first comparative example.

FIG. 8 is a cross-sectional view showing a lip portion of a sealing member that is provided at the vehicle back door structure relating to the first comparative example.

FIG. 9 is a cross-sectional view showing a lip portion of a sealing member that is provided at a vehicle back door structure relating to a second comparative example.

### DESCRIPTION OF EMBODIMENTS

Vehicle back door structures relating to embodiments of the present invention are described on the basis of the drawings. Note that arrow RR, arrow UP, arrow RH and arrow LH that are shown appropriately in the respective drawings indicate the rearward direction, the upward direction, the rightward direction when facing in the frontward direction, and the leftward direction when facing in the frontward direction, respectively of a vehicle to which the vehicle back door structures relating to the embodiments of the present invention are applied. Further, in the following description, when longitudinal, vertical and left-right directions are used without being indicated otherwise, they refer to the longitudinal of the longitudinal direction of the vehicle, the vertical of the vertical direction, and the left and the right of the left-right direction (the vehicle transverse direction) when facing in the frontward direction.

### First Embodiment

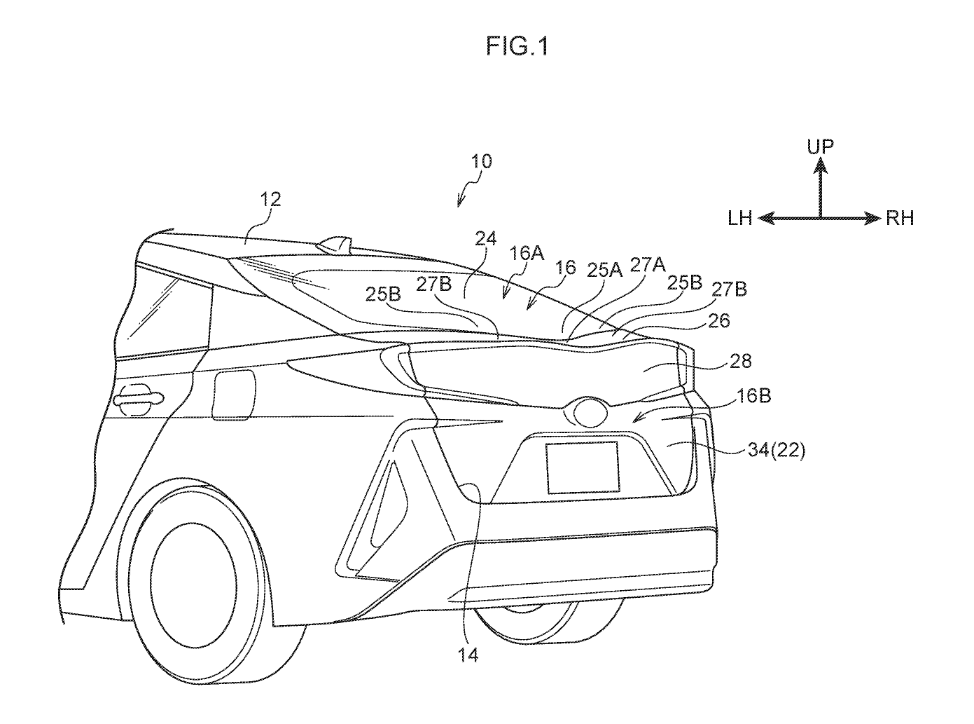

A vehicle back door structure relating to a first embodiment is described hereinafter by using FIG. 1 through FIG. 5.

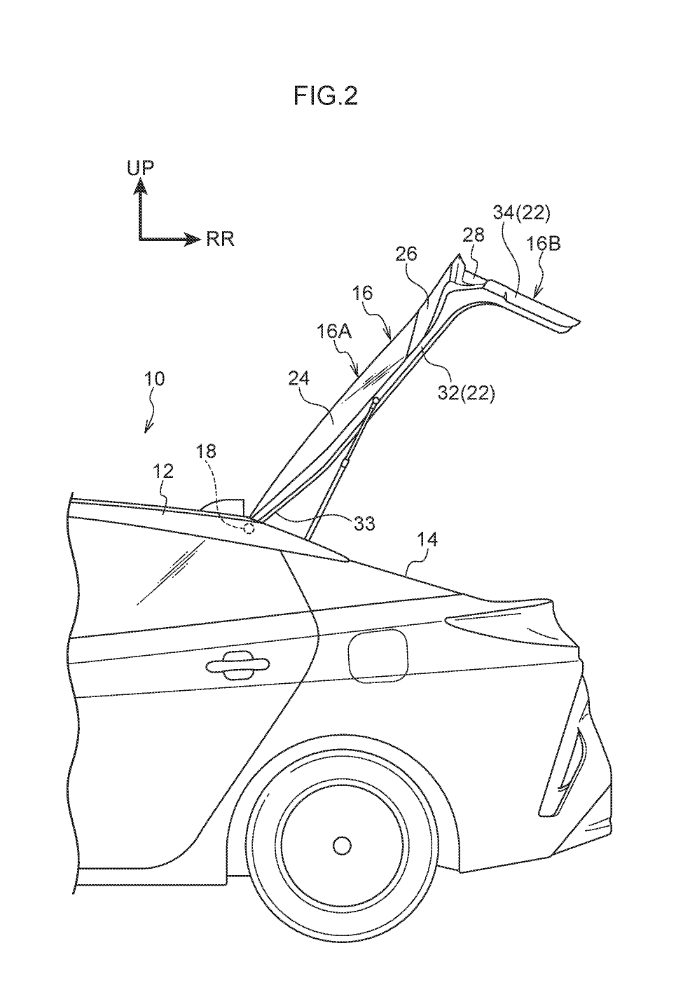

A vehicle 10, which is structured to include a vehicle body 12 and a back door 16, is shown in FIG. 1. As shown in FIG. 1, a door opening portion 14 that opens in the vehicle longitudinal direction is formed in the rear end of the vehicle body 12. Door hinges 18 (see FIG. 2), which support the back door 16 such that the back door 16 is rotatable with the vehicle transverse direction being the axial direction, are provided at the upper edge portion of the door opening portion 14 at the vehicle body 12 and at an upper edge portion 33 (see FIG. 2) of an inner panel 32 that is described later.

By being rotated around the door hinges 18 (see FIG. 2), the back door 16 can open and close the door opening portion 14. In FIG. 1, the back door 16 is disposed at a closed position at which the back door 16 closes the door opening portion 14. In FIG. 2, the back door 16 is disposed at an open position at which the back door 16 opens the door opening portion 14.

As shown in FIG. 2, the back door 16 is formed in a substantial L-shape as seen in a vehicle side view, and, in a state of being disposed at the closed position, closes the vehicle upper side and the vehicle rear side of the door opening portion 14 (see FIG. 1). Further, the back door 16 has (see FIG. 1) a door upper portion 16A, which extends gently from the upper end portion in the vehicle vertical direction toward a vehicle obliquely rear and lower side, and a door lower portion 16B, which hangs-down toward the vehicle lower side from the rear end portion in the vehicle longitudinal direction of the door upper portion 16A. Note that the placement of the respective portions that structure the back door 16 is explained with the back door 16 in a state of being disposed at the closed position.

As shown in FIG. 1 and FIG. 2, the back door 16 is structured to include a back door main body 22, a rear window 24 that is disposed at the upper portion side of the back door 16, a rear spoiler 26 that is disposed at the rear side of the rear window 24, and a lower window 28 for a small window that is disposed at the lower side of the rear spoiler 26. The rear window 24 is disposed at the door upper portion 16A, and the lower window 28 is disposed at the upper portion of the door lower portion 16B. The rear spoiler 26 is disposed between the rear window 24 and the lower window 28.

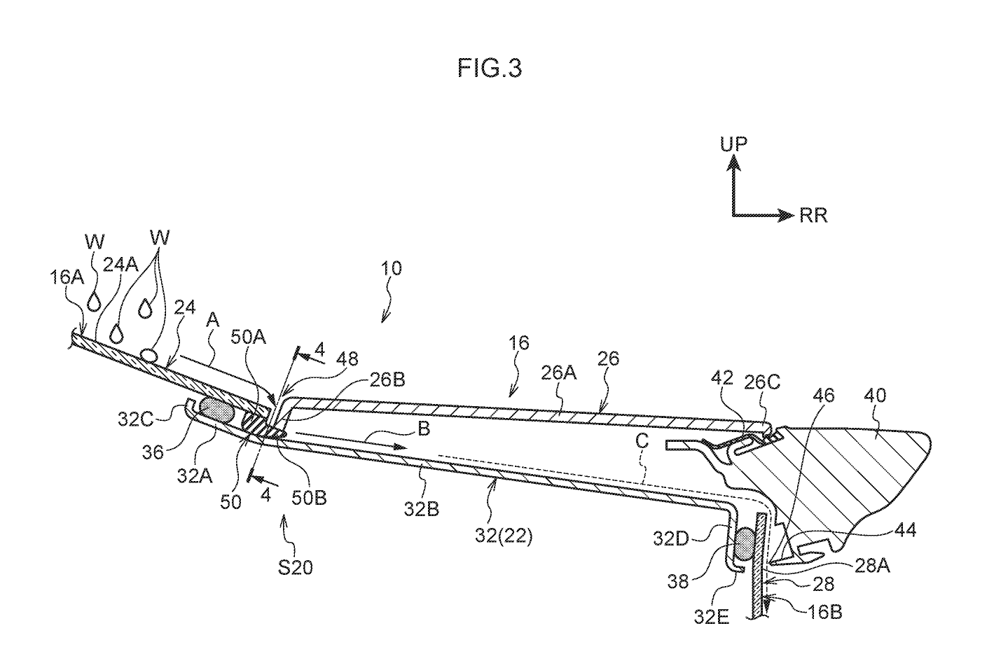

As shown in FIG. 3, a vehicle back door structure S20 of the first embodiment is applied to the back door 16. The back door main body 22 has the inner panel 32, which structures a portion of the back door 16 and is disposed at the vehicle inner side, and an outer panel 34 (see FIG. 1 and FIG. 2) that structures a portion of the back door 16 and is disposed at the vehicle outer side. The inner panel 32 has an upper side opening portion at which the rear window 24 is disposed, and a lower side opening portion at which the lower window 28 is disposed. The outer panel 34 (see FIG. 1 and FIG. 2) is disposed at the lower side of the lower window 28. The peripheral edge portions of the inner panel 32 and the outer panel 34 are joined by welding or adhesion or the like.

As shown in FIG. 3, a back door glass 24A is disposed in the rear window 24, and the back door glass 24A is inclined toward the vehicle lower side while heading toward the vehicle rear side. The inner panel 32 has a mounting portion 32A, to which the rear end portion of the back door glass 24A is mounted, and an inclined portion 32B, which is provided to extend from the mounting portion 32A toward the rear side in the vehicle longitudinal direction and is sloped downward toward the vehicle rear side. The inclined portion 32B is inclined gently at a downward slope toward the vehicle rear side. In the first embodiment, the inclined portion 32B is formed over substantially the entire transverse direction of the inner panel 32. Further, the inner panel 32 has, at the front end portion of the mounting portion 32A, a flange portion 32C that is bent toward the vehicle upper side. Moreover, the inner panel 32 has a vertical wall portion 32D, which extends toward the vehicle lower side from the rear end portion of the inclined portion 32B, and a flange portion 32E, which is bent toward the vehicle rear side from the lower end portion of the vertical wall portion 32D.

The rear end portion of the back door glass 24A is provided so as to extend to the upper side of the mounting portion 32A of the inner panel 32. An adhesion portion 36 at which an adhesive is disposed is provided at the upper surface of the mounting portion 32A of the inner panel 32. The reverse surface side of the rear end portion of the back door glass 24A is adhered by the adhesive portion 36 to the upper surface of the mounting portion 32A of the inner panel 32.

A lower glass 28A is disposed in the lower window 28. The lower glass 28A is disposed substantially along the vehicle vertical direction. The upper end portion of the lower glass 28A is provided so as to extend to the rear side of the vertical wall portion 32D of the inner panel 32. An adhesion portion 38 at which an adhesive is disposed is provided at the rear surface of the vertical wall portion 32D of the inner panel 32. The reverse surface side of the upper end portion of the lower glass 28A is adhered by the adhesion portion 38 to the rear surface of the vertical wall portion 32D of the inner panel 32.

The rear spoiler 26 is disposed at the upper side in the vehicle vertical direction of the inclined portion 32B of the inner panel 32. The rear spoiler 26 has a wall portion 26A that is disposed substantially in the vehicle longitudinal direction, a bent portion 26B that is bent substantially toward the vehicle lower side from the front end portion of the wall portion 26A, and a rear end portion 26C at the rear side in the vehicle longitudinal direction of the wall portion 26A. A projecting portion, which is slightly bent toward the vehicle lower side from the wall portion 26A is formed at the rear end portion 26C. Although not illustrated, the rear spoiler 26 is made of resin for example, and is joined by adhesion or the like to the inner panel 32 at the both end portions in the vehicle transverse direction and at plural places in the vehicle transverse direction.

A high mount stop lamp 40 is provided at the rear side of the rear spoiler 26. The high mount stop lamp 40 is a shape that projects-out in a convex form toward the vehicle rear side. A sealing member 42 is disposed between the rear spoiler 26 and the high mount stop lamp 40. The high mount stop lamp 40 is mounted by adhesion or the like to the rear portion of the wall portion 26A of the rear spoiler 26. A projecting portion 44, which projects-out from the rear side in the vehicle longitudinal direction toward the lower glass 28A side in front, is provided at the lower portion of the high mount stop lamp 40. A drainage portion 46 from which water W that is described later is drained-out is formed between the projecting portion 44 and the lower glass 28A. The drainage portion 46 is an opening portion into which the water W flows. In other words, the drainage portion 46 is formed between the rear end portion side of the inner panel 32 (in the first embodiment, the lower window 28 at the rear end portion side of the inner panel 32) and the rear portion side of the rear spoiler 26 (in the first embodiment, the high mount stop lamp 40 at the rear portion side of the rear spoiler 26).

As shown in FIG. 1, in a state of being viewed from the vehicle rear side, at least the front portion side of the upper surface of the wall portion 26A (see FIG. 3) of the rear spoiler 26 has, at the substantially central portion thereof in the vehicle transverse direction, a concave surface 27A that is gently curved in a concave form toward the vehicle lower side, and has, at the vehicle transverse direction both sides of the concave surface 27A, convex surfaces 27B that are gently curved in convex forms toward the vehicle upper side. Here, the concave surface 27A is an example of a concave surface that is recessed toward the vehicle lower side. Namely, at least the front portion side of the upper surface of the wall portion 26A of the rear spoiler 26 is formed in a substantially upside-down W-shape (a substantial M-shape) in a state of being viewed from the vehicle rear side.

Further, in a state of being viewed from the vehicle rear side, at least the rear portion side of the upper surface of the back door glass 24A (see FIG. 3) that is disposed at the rear window 24 has, at the substantially central portion thereof in the vehicle transverse direction, a concave surface 25A that is gently curved in a concave form toward the vehicle lower side, and has, at the vehicle transverse direction both sides of the concave surface 25A, convex surfaces 25B that are gently curved in convex forms toward the vehicle upper side. Here, the concave surface 25A is an example of a concave surface that is recessed toward the vehicle lower side. The concave surface 25A of the rear window 24 is provided at a position that corresponds to the concave surface 27A of the rear spoiler 26 in the vehicle transverse direction. The two convex surfaces 25B of the rear window 24 are provided at positions that correspond to the two convex surfaces 27B of the rear spoiler 26 in the vehicle transverse direction.

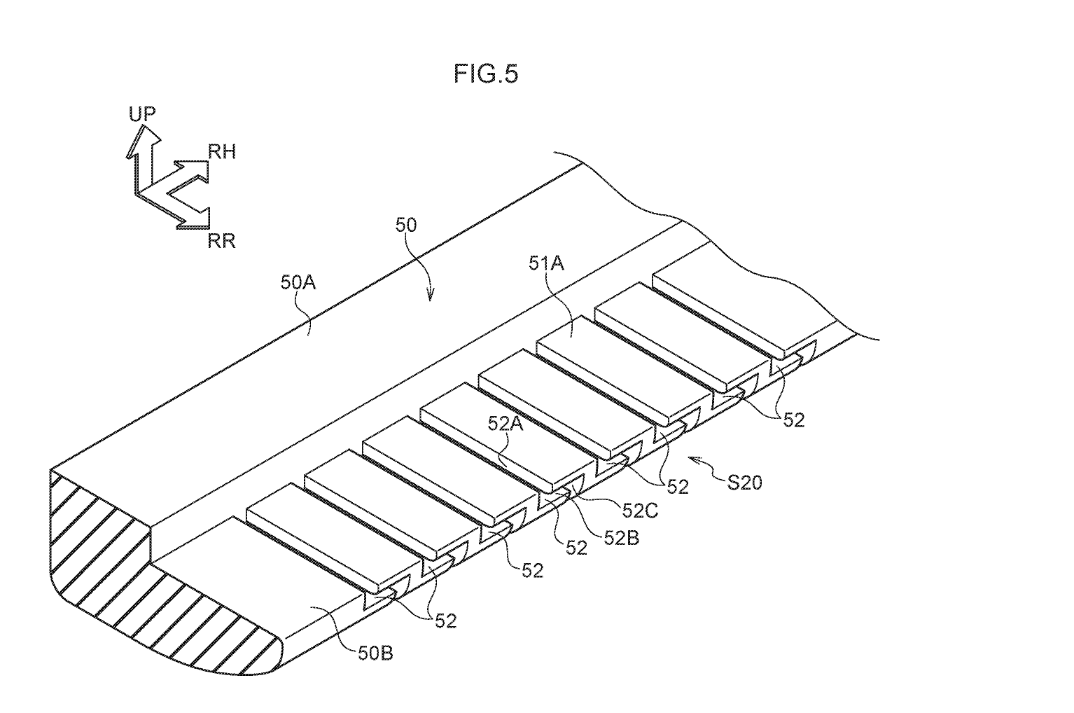

As shown in FIG. 3, a sealing member 50, which seals between the rear end portion of the rear window 24 and the inner panel 32, is provided at a mating portion 48 of the rear end portion of the rear window 24 and the front end portion of the rear spoiler 26. The rear end portion of the back door glass 24A at the rear window 24 is provided so as to extend further toward the rear side than the position of the adhesion portion 36 of the mounting portion 32A of the inner panel 32. The sealing member 50 is mounted to the reverse surface of the rear end portion of the back door glass 24A, at further toward the rear side than the position of the adhesion portion 36. As seen in a vehicle side view, the sealing member 50 is formed in a substantial L-shape. More concretely, as shown in FIG. 3 and FIG. 5, the sealing member 50 has a base portion 50A, which is disposed at the vehicle front side and whose length in the vehicle vertical direction is long, and a lip portion 50B, which is disposed at the vehicle rear side of the base portion 50A and whose length in the vehicle vertical direction is shorter than that of the base portion 50A. The lip portion 50B extends toward the vehicle rear side from the base portion 50A.

As shown in FIG. 3, the upper surface of the base portion 50A is joined by adhesion or the like to the reverse surface (the lower surface in FIG. 3) of the rear end portion of the back door glass 24A. The lower surface of the base portion 50A contacts the mounting portion 32A of the inner panel 32. Note that the lower surface of the base portion 50A may be joined by adhesion or the like to the mounting portion 32A of the inner panel 32. The distal end portion of the lip portion 50B contacts the bent portion 26B of the rear spoiler 26, and extends further toward the rear side than the bent portion 26B. In other words, the lip portion 50B of the sealing member 50 is structured so as to extend from the reverse surface side of the rear end portion of the rear window 24 and contact the reverse surface side of the front end portion of the rear spoiler 26.

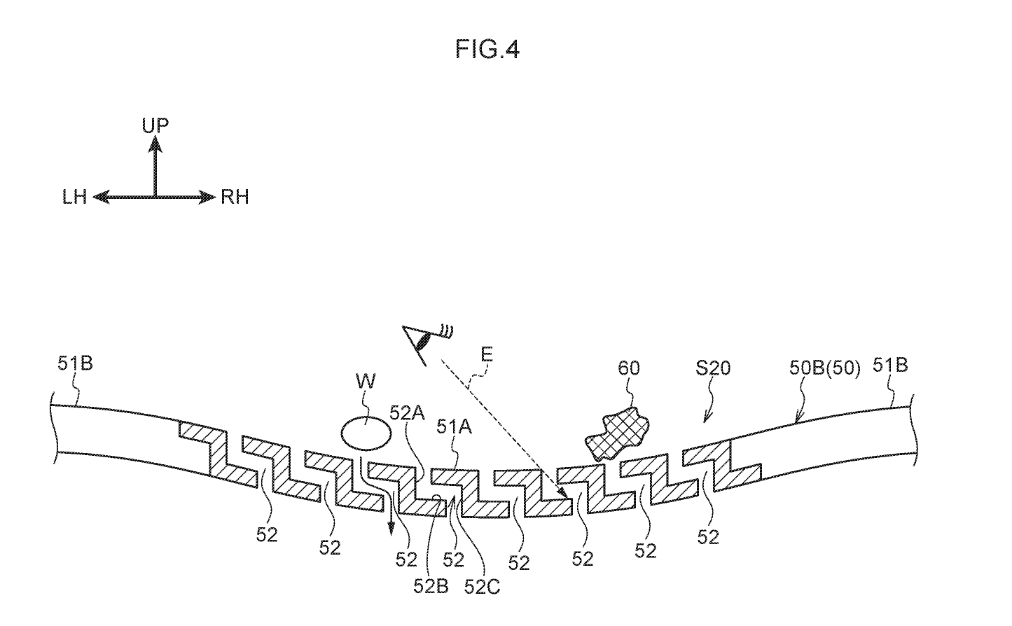

As shown in FIG. 4, as seen in a cross-section along the vehicle transverse direction, the upper surface of the sealing member 50 is made to be a shape that matches the shapes of the upper surface of the rear spoiler 26 and the upper surface (see FIG. 1) of the back door glass 24A. More concretely, the upper surface of the lip portion 50B of the sealing member 50 has, at the substantially central portion thereof in the vehicle transverse direction, a concave surface 51A that is gently curved in a concave shape toward the vehicle lower side, and has, at the vehicle transverse direction both sides of the concave surface 51A, convex surfaces 51B that are gently curved in convex shapes toward the vehicle upper side (see FIG. 1). Namely, the upper surface of the lip portion 50B of the sealing member 50 is formed in a substantially upside-down W-shape (a substantial M-shape).

As shown in FIG. 4 and FIG. 5, the sealing member 50 has, at the region of the lip portion 50B where the concave surface 51A is provided, plural slits 52 that communicate the mating portion 40 side (see FIG. 3) and the reverse surface side (the upper surface side) (see FIG. 3) of the inner panel 32. The plural slits 52 of the lip portion 50B are provided at a position corresponding to the concave surface 25A of the back door glass 24A (see FIG. 1) and the concave surface 27A of the rear spoiler 26 (see FIG. 1) in the vehicle transverse direction. The upper portions of the slits 52 open at the upper surface of the lip portion 50B, and the lower portions open at the lower surface of the lip portion 50B. The openings at the upper portions of the slits 52 are disposed along the vehicle longitudinal direction. In the first embodiment, the slits 52 are formed over substantially the entire length in the longitudinal direction of the lip portion 50B.

As seen from the vehicle rear side, the slits 52 are formed in the shapes of steps. In other words, as seen from the vehicle rear side, the cross-section of the lip portion 50B is formed in a substantial Z-shape, and, as seen from the vehicle rear side, the cross-sections of the slits 52 are formed in the shapes of cranks. More concretely, the slit 52 has an upper lengthwise hole 52A that is disposed at the substantially vehicle lower side from the upper surface of the lip portion 50B, a lateral hole 52B that is disposed at a substantially vehicle transverse direction one side (in the first embodiment, the vehicle transverse direction right side) from the lower end portion of the upper lengthwise hole 52A, and a lower lengthwise hole 52C that is disposed at the substantially vehicle lower side from the end portion at a substantially vehicle transverse direction one side (in the first embodiment, the vehicle transverse direction right side) of the lateral hole 52B.

By forming the cross-section of the slit 52 in the shape of a step as seen from the vehicle rear side, when the slit 52 is viewed from the vehicle upper side as shown by sightline E in FIG. 4, it is difficult to see the inner panel 32 (see FIG. 3) that is at the lower side of the lip portion 50B.

Further, due to the cross-sections of the slits 52 being formed in the shapes of steps as seen from the vehicle rear side, as shown in FIG. 4, foreign matter 60 such as debris or the like (e.g., dead leaves or pebbles or the like) passing-through the slits 52 and entering-in between the inner panel 32 and the rear spoiler 26 is suppressed. Namely, due to the slits 52 being formed in the shapes of steps as seen from the vehicle rear side, there is a structure that blocks the foreign matter 60.

Further, the slits 52 of the lip portion 50B communicate the mating portion 48 (see FIG. 3) side and the reverse surface side (the upper surface side shown in FIG. 3) of the inner panel 32 (see FIG. 3). Due thereto, as shown by arrow A in FIG. 3, when the water (water drops) W flow down the back door glass 24A and enter into the mating portion 48 between the rear end portion of the rear window 24 and the front end portion of the rear spoiler 26, the water W passes-through the slits 52. Namely, the water W at the mating portion 48 side passes-through the slits 52, and comes-out at the obverse side (the upper surface side shown in FIG. 3) of the inner panel 32. Moreover, as shown by arrow B, the water W flows on the inclined portion 32B of the inner panel 32 toward the lower window 28 side.

As shown in FIG. 3, the drainage portion 46 is formed between the projecting portion 44 and the lower glass 28A. Due thereto, the water W, which flows from the inclined portion 32B of the inner panel 32 to the lower glass 28A side of the lower window 28, passes-through the drainage portion 46 and is discharged-out to the exterior of the back door 16.

Operation and effects of the first embodiment are described next.

As shown in FIG. 3, at the back door 16 that has the vehicle back door structure S20, the inner panel 32 is joined by the adhesion portion 36 to the reverse surface of the rear end portion of the rear window 24. The inner panel 32 is provided so as to extend from the rear end portion of the rear window 24 toward the vehicle rear side. The rear spoiler 26 is provided at the upper side in the vertical direction of the inclined portion 32B of the inner panel 32. The sealing member 50 is provided at the mating portion 48 of the rear end portion of the rear window 24 and the front end portion of the rear spoiler 26. The lip portion 50B, which extends from the reverse surface side of the rear end portion of the rear window 24 and contacts the reverse surface side of the front end portion of the rear spoiler 26, is formed at the sealing member 50. The lip portion 50B has the plural slits 52 (see FIG. 4 and FIG. 5), which communicate the mating portion 48 side and the obverse side (the upper surface side shown in FIG. 3) of the inner panel 32, at the position where the concave surface 51A is provided at the vehicle transverse direction central portion.

Due thereto, as shown by arrow A in FIG. 3, the water W that flows on the back door glass 24A of the rear window 24 flows to the mating portion 48 of the rear end portion of the rear window 24 and the front end portion of the rear spoiler 26. At this time, the water W passes-through the plural slits 52 (see FIG. 4 and FIG. 5) of the lip portion 50B of the sealing member 50, and, as shown by arrow B, flows on the obverse of the inner panel 32 (namely, the upper surface of the inclined portion 32B) that is at the lower side of the rear spoiler 26. Due thereto, the water W collecting at the mating portion 48 of the rear end portion of the rear window 24 and the front end portion of the rear spoiler 26 is suppressed.

Further, at the vehicle back door structure S20, the rear window 24 has, at the central portion thereof in the vehicle transverse direction, the concave surface 25A that is recessed toward the vehicle lower side, and the rear spoiler 26 has, at the central portion thereof in the vehicle transverse direction, the concave surface 27A that is recessed toward the vehicle lower side (see FIG. 1). The lip portion 50B has the concave surface 51A (see FIG. 4) that is recessed toward the vehicle lower side, at a position corresponding to the concave surface 25A and the concave surface 27A. The plural slits 52 of the lip portion 50B are formed at least at the concave surface 51A that corresponds to the concave surface 25A and the concave surface 27A. Due thereto, the water W, which flows to the low regions that are the concave surfaces 25A, 27A and the concave surface 51A, passes-through the slits 52 of the lip portion 50B and can flow to the obverse of the inner panel 32 (namely, the upper surface of the inclined portion 32B) that is at the lower side of the rear spoiler 26, and the water W does not collect at the concave surfaces 25A, 27A and the concave surface 51A. Therefore, when the back door 16 is opened (se FIG. 2), water that has collected at the concave surfaces 25A, 27A and the concave surface 51A flowing into the vehicle cabin interior from the front end portion of the rear window 24 is suppressed, and the degrees of freedom in design can be improved.

Further, as shown in FIG. 4 and FIG. 5, the cross-sections of the slits 52 of the lip portion 50B are formed in the shapes of steps, as seen from the vehicle rear side along the surface of the rear window 24. Therefore, as shown by sightline E in FIG. 4, at the vehicle back door structure S20, the inner panel 32 (see FIG. 3) that is at the lower side being seen from the slits 52 of the lip portion 50B is suppressed and a deterioration in the appearance is suppressed, as compared with a case in which slits are formed in rectilinear forms in the substantially vehicle vertical direction. Further, due to the cross-sections of the slits 52 being formed in the shapes of steps as seen from the vehicle rear side, as shown in FIG. 4, the foreign matter 60 such as trash or the like passing-through the slits 52 and entering in between the inner panel 32 and the rear spoiler 26 is suppressed. Further, in a case in which the inner panel 32 is formed of a resin such as a carbon-fiber-reinforced plastic (CFRP) or the like for example, passing of ultraviolet light through the slits 52 of the lip portion 50B so as to hit the inner panel 32 (see FIG. 3) that is at the lower side is suppressed, and deterioration of the inner panel 32 due to ultraviolet light can be suppressed.

Moreover, in the vehicle back door structure S20, the inner panel 32 has the inclined portion 32B that slopes downward toward the vehicle rear side. Therefore, as shown by arrow C in FIG. 3, the water W that has passed-through the slits 52 of the lip portion 50B flows on the upper surface of the inclined portion 32B toward the vehicle rear side. Moreover, the drainage portion 46 is provided at the rear end portion side of the inner panel 32, between the lower glass 28A and the projecting portion 44 that is at the rear portion side of the rear spoiler 26. Due thereto, as shown by arrow C in FIG. 3, the water W that has flowed to the rear end portion side of the inner panel 32 is discharged-out to the exterior of the back door 16 from the drainage portion 46 that is between the lower glass 28A and the projecting portion 44 that is at the rear portion side of the rear spoiler 26. Therefore, stagnating of the water W, which has passed-through the slits 52 of the lip portion 50B and flows on the obverse of the inner panel 32, is suppressed, and the water W can be discharged smoothly from the drainage portion 46.

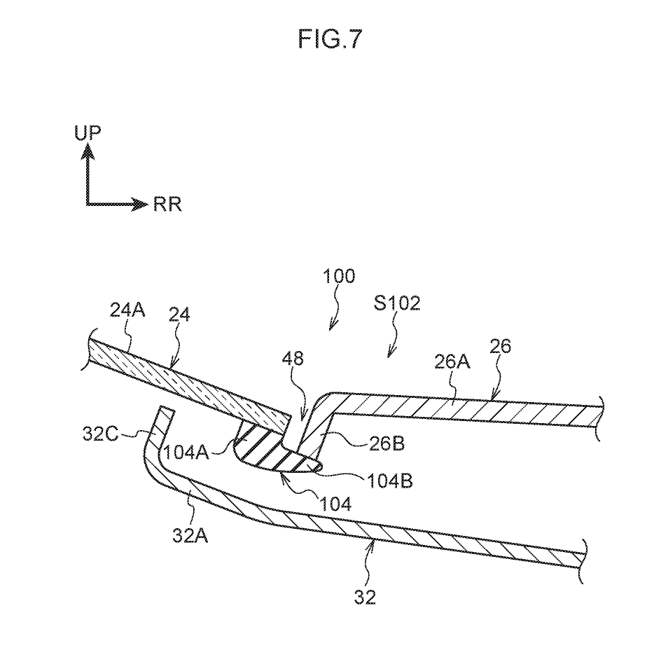

A portion of a back door 100, to which a vehicle back door structure S102 of a first comparative example is applied, is shown in FIG. 7 in an enlarged cross-sectional view. As shown in FIG. 7, at the back door 100, a sealing member 104 is provided at the mating portion 48 of the rear end portion of the rear window 24 and the front end portion of the rear spoiler 26. The cross-section that is shown in FIG. 7 of the sealing member 104 is formed in a substantial L-shape. The sealing member 104 has a base portion 104A, which is disposed at the vehicle front side and whose length in the vehicle vertical direction is long, and a lip portion 104B, which is disposed at the vehicle rear side of the base portion 104A and whose length in the vehicle vertical direction is short. The upper surface of the base portion 104A is joined by adhesion or the like to the reverse surface of the rear end portion of the back door glass 24A. The lip portion 104B extends from the base portion 104A toward the vehicle rear side. The distal end portion of the lip portion 104B contacts the bent portion 26B of the rear spoiler 26 and extends further toward the rear side than the bent portion 26B.

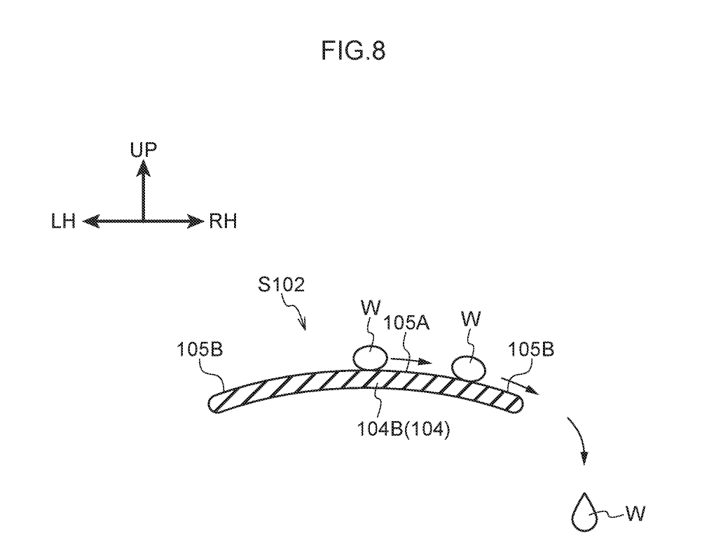

The lip portion 104B of the sealing member 104 is shown in FIG. 8 in a cross-sectional view along the vehicle transverse direction. As shown in FIG. 8, the upper surface of the lip portion 104B is configured as a convex curved surface in which a central portion 105A in the vehicle transverse direction projects out toward the vehicle upper side, and end portions 105B at vehicle transverse direction both sides are disposed at the vehicle lower side. Slits are not provided in the lip portion 104B of the sealing member 104. Therefore, the water W, which has entered from the rear window 24 into the mating portion 48 (see FIG. 7) of the rear end portion of the rear window 24 and the front end portion of the rear spoiler 26, flows along the curved surface of the upper surface of the lip portion 104B from the central portion 105A in the vehicle transverse direction toward the end portions 105B at the vehicle transverse direction outer sides, and drips-down toward the vehicle lower side from the end portions 105B at the vehicle transverse direction outer sides of the lip portion 104B.

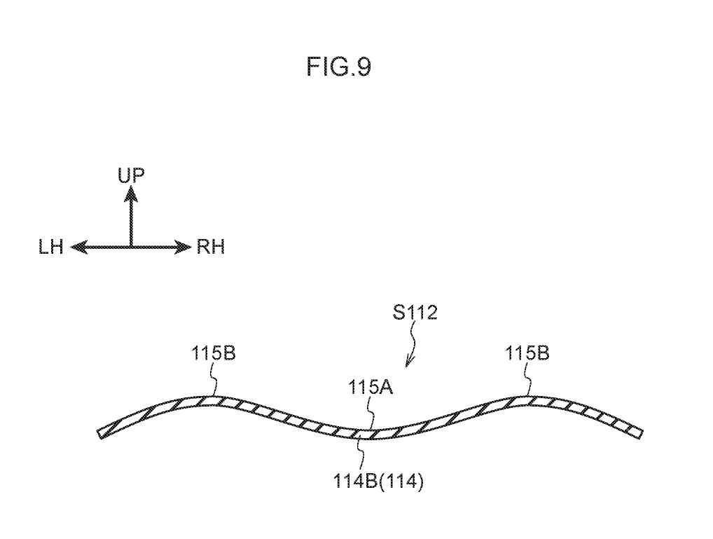

A lip portion 114B of a sealing member 114, to which a vehicle back door structure S112 of a second comparative example is applied, is shown in FIG. 9 in a cross-sectional view along the vehicle transverse direction. As shown in FIG. 9, the top surface of the lip portion 114B has, at the substantially central portion thereof in the vehicle transverse direction, a concave surface 115A that is gently curved in a concave shape toward the vehicle lower side, and has, at the vehicle transverse direction both sides of the concave surface 115A, convex surfaces 115B that are gently curved in convex shapes toward the vehicle upper side. Namely, the upper surface of the lip portion 114B of the sealing member 114 is formed in a substantially upside-down W-shape (a substantial M-shape) (see FIG. 1). Slits are not provided in the lip portion 114B of the sealing member 114.

Although not illustrated, the sealing member 114 is provided at the mating portion 48 (see FIG. 7) of the rear end portion of the rear window 24 and the front end portion of the rear spoiler 26. In the above-described vehicle back door structure S112, there is the possibility that water, which has entered from the rear window 24 into the mating portion 48 (see FIG. 7) of the rear end portion of the rear window 24 and the front end portion of the rear spoiler 26, will collect in the vicinity of the concave surface 115A of the lip portion 114B.

In contrast, as shown in FIG. 4 and the like, in the vehicle back door structure S20 of the first embodiment, the lip portion 50B of the sealing member 50 has the plural slits 52 at the position of the concave surface 51A at the central portion in the vehicle transverse direction. Due thereto, the water W which flows to the concave surface 51A of the lip portion 50B passes-through the slits 52 of the lip portion 50B, and can flow to the obverse of the inner panel 32 that is at the lower side of the rear spoiler 26, and the water W collecting in a vicinity of the concave surface 51A of the lip portion 50B can be suppressed.

### Second Embodiment

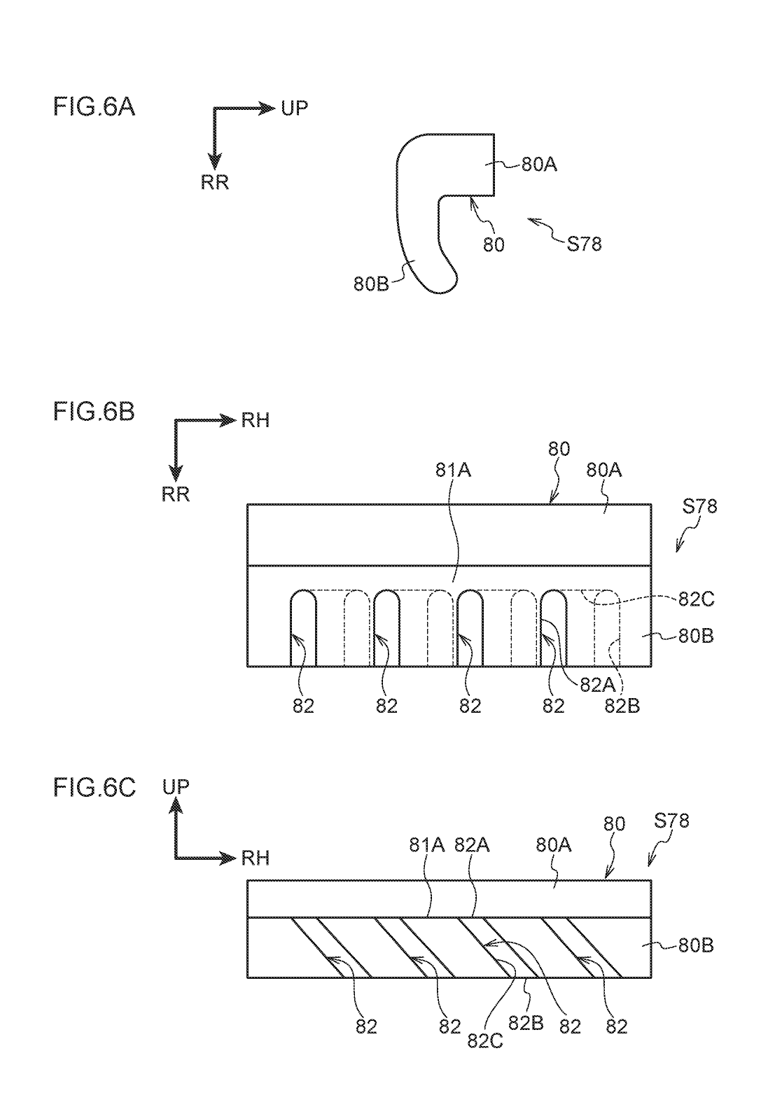

A vehicle back door structure relating to a second embodiment is described next by using FIG. 6A through FIG. 6C. Note that, in the second embodiment, structural elements, members and the like that are the same as those of the first embodiment are denoted by the same reference numerals, and detailed description thereof is omitted.

A side view of a sealing member 80 that is used in a vehicle back door structure S78 relating to the second embodiment, a plan view of a portion of the sealing member 80, and a rear view of a portion of the sealing member 80 are shown in FIG. 6A through FIG. 6C. As shown in FIG. 6A through FIG. 6C, the sealing member 80 has a base portion 80A, which is disposed at the vehicle front side and whose length in the vehicle vertical direction is long, and a lip portion 80B, which is disposed at the vehicle rear side of the base portion 80A and whose length in the vehicle vertical direction is short. The lip portion 80B extends from the base portion 80A toward the vehicle rear side.

Although not illustrated, the position, at which the sealing member 80 is provided at the vehicle back door structure S78, is the same as the position at which the sealing member 50 (see FIG. 3) of the first embodiment is provided. Although not illustrated, the upper surface of the base portion 80A is joined by adhesion or the like to the reverse surface of the rear end portion of the back door glass 24A (see FIG. 3). The distal end portion of the lip portion 80B contacts the bent portion 26B (see FIG. 3) of the rear spoiler 26 and extends further toward the rear side than the bent portion 26B.

The upper surface of the lip portion 80B of the sealing member 80 has, at the substantially central portion thereof in the vehicle transverse direction, a concave surface 81A that is gently curved in a concave shape toward the vehicle lower side, and has, at the vehicle transverse direction both sides of the concave surface 81A, convex surfaces (not shown) that are gently curved in convex shapes toward the vehicle upper side. Namely, the upper surface of the lip portion 80B of the sealing member 80 is formed in a substantially upside down W-shape (a substantial M-shape).

The sealing member 80 has plural slits 82 at the region where the concave surface 81A is provided at the lip portion 80B. The slits 82 are made to be shapes that communicate the mating portion 48 side and the obverse side of the inner panel 32 (see FIG. 3). As seen from the vehicle rear side, the slits 82 are formed in the shapes of inclined surfaces that are inclined with respect to the upper surface of the lip portion 80B. More concretely, the slit 82 has an opening portion 82A that opens at the upper surface of the lip portion 80B, an opening portion 82B that opens at the lower surface of the lip portion 80B and that is disposed at a position that is offset substantially parallel to the opening portion 82A as seen in a plan view, and a hole portion 82C that connects the opening portion 82A and the opening portion 82B. The hole portion 82C is formed in a substantially rectilinear shape, and has an inclined surface portion that is disposed in a direction of being inclined with respect to the upper surface of the lip portion 80B.

In the above-described vehicle back door structure S78, the water W (see FIG. 3), which has flowed to the mating portion 48 of the rear end portion of the rear window 24 and the front end portion of the rear spoiler 26, passes-through the plural slits 82 of the lip portion 80B of the sealing member 80, and flows to the upper surface of the inclined portion 32B of the inner panel 32 that is at the lower side of the rear spoiler 26. Due thereto, collecting of the water W at the mating portion 48 of the rear end portion of the rear window 24 and the front end portion of the rear spoiler 26 is suppressed.

Further, as seen from the vehicle rear side, the slits 82 of the lip portion 80B are formed in the shapes of inclined surfaces that are inclined with respect to the upper surface of the lip portion 80B. Due thereto, at the vehicle back door structure S78, the inner panel 32 (see FIG. 3) at the lower side being seen from the slits 82 of the lip portion 80B is suppressed and a deterioration in the appearance is suppressed, as compared with a case in which slits are formed in rectilinear forms in the substantially vehicle vertical direction. Further, in a case in which the inner panel 32 is formed of a resin such as a carbon-fiber-reinforced plastic (CFRP) or the like for example, passing of ultraviolet light through the slits 82 of the lip portion 80B so as to hit the inner panel 32 (see FIG. 3) at the lower side is suppressed, and deterioration of the inner panel 32 due to ultraviolet light can be suppressed.

Moreover, the cross-section of the lip portion 80B is made to be the shape of an inclined surface due to the slits 82. Due thereto, a structure is provided that can be molded merely by cutting, at the mold, a regular lip that has no slits, and the produceability can be improved.

Note that the shape of the sealing member is not limited to the shapes of the sealing members 50, 80 of the first embodiment and the second embodiment, and can be changed. The sealing members 50, 80 have, at the vehicle transverse direction central portions thereof, the concave surfaces 51A, 81A that are recessed in concave forms toward the vehicle lower side, and have, at the vehicle transverse direction both sides of the concave surfaces 51A, 81A, the convex surfaces 51B that project-out toward the vehicle upper side. However, for example, the sealing members 50, 80 may be shapes that do not have convex surfaces. Further, the sealing member may be a curved shape whose vehicle transverse direction central portion projects-out further toward the vehicle upper side than the vehicle transverse direction both end portions thereof.

Further, the shapes of the rear window and the rear spoiler are not limited to the shapes of the rear window 24 and the rear spoiler 26 of the first embodiment, and can be changed. The rear window 24 and the rear spoiler 26 have, at the vehicle transverse direction central portions thereof, the concave surfaces 25A, 27A that are recessed in concave forms toward the vehicle lower side, and have, at the vehicle transverse direction both sides of the concave surfaces 25A, 27A, the convex surfaces 25B, 27B that project-out toward the vehicle upper side. However, for example, the rear window 24 and the rear spoiler 26 may shapes that do not have convex surfaces. Further, the rear window and the rear spoiler may be curved shapes whose vehicle transverse direction central portions project-out further toward the vehicle upper side than the vehicle transverse direction both end portions thereof.

Further, also the shapes of the slits that are provided at the lip portion of the sealing member are not limited to the shapes of the slits 52, 82 that are provided at the lip portions 50B, 80B of the sealing members 50, 80 of the first embodiment and the second embodiment, and can be changed. Further, the slits that are provided at the lip portion of the sealing member may be a shape that is other than the shape of a step or the shape of an inclined surface in the state of being seen from the vehicle rear side. For example, the slits that are provided at the lip portion of the sealing member may be changed to be a shape such as a substantial S-shape, a substantial C-shape, a substantial L-shape disposed so as to be tilted with respect to the horizontal direction, or the like, in the state of being seen from the vehicle rear side. Further, the slits that are provided at the lip portion of the sealing member may be a shape in which the number of openings into which water flows and the number of openings from which water is discharged differ, such as a substantial Y-shape or the like, in a state of being seen from the vehicle rear side.

Further, in the first embodiment and the second embodiment, the lip portions 50B, 80B of the sealing members 50, 80 have the plural slits 52, 82 in the vehicle transverse direction, but the present disclosure is not limited to this structure. For example, in a case in which the rear window 24 and the rear spoiler 26 have, at the vehicle transverse direction central portions thereof, the concave surfaces 25A, 27A that are recessed in concave forms toward the vehicle lower side, there may be a structure in which slits are provided at at least one place in the vehicle transverse direction of the lip portion that corresponds to the concave surfaces 25A, 27A. Further, for example, in a case in which the rear window and the rear spoiler are formed in curved shapes in which, as seen from the vehicle rear side, the vehicle transverse direction central portion projects-out in a convex shape further toward the vehicle upper side than the vehicle transverse direction both end portions, slits may be provided at the vehicle transverse direction outer sides of the lip portion. Further, plural slits may be provided at the entire region, in the vehicle transverse direction, of the lip portion of the sealing member.

Further, in the first embodiment and the second embodiment, the inner panel 32 has, at substantially the entirety thereof in the vehicle transverse direction, the inclined portion 32B that is inclined so as to slope downward toward the vehicle rear side, but the present disclosure is not limited to this structure. For example, there may be a structure in which the inner panel 32 has, at least one portion of the inner panel 32 in the vehicle transverse direction, an inclined portion that slopes downward toward the vehicle rear side. Further, the drainage portion as well is not limited to the drainage portion 46 that is provided along the vehicle transverse direction at the rear end portion side of the inner panel 32 of the first and second embodiments, and there may be a structure in which a drainage portion is formed at a portion in the vehicle transverse direction of the rear end portion side of the inner panel 32.

Further, in the first embodiment and the second embodiment, the sealing members 50, 80 are mounted by adhesion or the like to the reverse surface of the rear end portion of the back door glass 24A, but the present disclosure is not limited to this structure. For example, there may be a structure in which the sealing member is mounted by adhesion or the like to the back door main body such as the inner panel or the like.

Moreover, in the first embodiment and the second embodiment, there are structures in which the sealing members 50, 80 are mounted to the reverse surface of the rear end portion of the rear window 24, and the lip portions 50B, 80B contact the reverse surface side of the front end portion of the rear spoiler 26. However, the present disclosure is not limited to this structure. For example, there may be a structure in which the sealing member is mounted to the reverse surface of the front end portion of the rear spoiler 26, and the lip portion contacts the reverse surface side of the rear end portion of the rear window 24.

Note that, although forms of implementing the present invention have been described by using embodiments as examples, these embodiments are examples, and the present invention can be implemented by being changed in various ways within a scope that does not depart from the gist thereof. Further, the scope of the right of the present invention is not limited to these embodiments, and, it goes without saying that the present invention can be implemented in various forms within a scope that does not depart from the gist thereof.

The disclosure of Japanese Patent Application No. 2016-207616 that was filed on Oct. 24, 2016 is, in its entirety, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

### EXPLANATION OF REFERENCE NUMERALS

10 vehicle
16 back door
22 back door main body
24 rear window
25A concave surface (concave surface)
26 rear spoiler
27A concave surface (concave surface)
32 inner panel (back door main body)
32B inclined portion
46 drainage portion
48 mating portion
50 sealing member
50B lip portion
52 slit
80 sealing member
80B lip portion
82 slit
S20 vehicle back door structure
S78 vehicle back door structure

What is claimed is:

1. A vehicle back door structure comprising:
a rear window that is inclined toward a vehicle lower side while heading toward a vehicle rear side;
a back door main body that is joined to a reverse surface side of a rear end portion of the rear window, and that is provided so as to extend from the rear end portion of the rear window toward the vehicle rear side;
a rear spoiler that is provided at an upper side, in a vertical direction, of the back door main body;
a sealing member that is provided at a mating portion of the rear end portion of the rear window and a front end portion of the rear spoiler, and that seals between the rear end portion of the rear window and the back door main body; and
a lip portion that is formed at the sealing member, extends from the reverse surface side of the rear end portion of the rear window and contacts a reverse surface side of the front end portion of the rear spoiler, and that has, at least one place thereof in a vehicle transverse direction, slits that communicate a mating portion side and an obverse side of the back door main body.

2. The vehicle back door structure of claim 1, wherein:
the rear window and the rear spoiler have, at vehicle transverse direction central portions thereof, concave surfaces that are recessed toward the vehicle lower side, and
the slits of the lip portion are provided at least at a position corresponding to the concave surfaces.

3. The vehicle back door structure of claim 1, wherein the slits of the lip portion are formed in shapes of steps as seen from the vehicle rear side along a surface of the rear window.

4. The vehicle back door structure of claim 1, wherein the slits of the lip portion are formed in shapes of inclined surfaces as seen from the vehicle rear side along a surface of the rear window.

5. The vehicle back door structure of claim 1, wherein:
the back door main body has, at least a portion thereof in the vehicle transverse direction, an inclined portion that is sloped downward while heading toward the vehicle rear side and at which water, which has passed through the slits, flows toward the vehicle rear side, and
a drainage portion, from which water that has flowed at the inclined portion is discharged, is provided between a rear end portion side of the back door main body and a rear portion side of the rear spoiler.

6. The vehicle back door structure of claim 1, wherein:
the sealing member is mounted to a reverse surface of the rear end portion of the rear window, and
the lip portion contacts a reverse surface side of the front end portion of the rear spoiler.

7. The vehicle back door structure of claim 1, wherein:
the sealing member has a base portion that is disposed at a vehicle front side and whose length in a vehicle vertical direction is long, and
a length of the lip portion in the vehicle vertical direction is shorter than that of the base portion, and the lip portion is disposed at a vehicle rear side of the base portion.
